(19) United States
(12) Patent Application Publication
(10) Pub. No.: US 2026/0299244 A1
(43) Pub. Date: Oct. 1, 2026

(54) OPTICAL FIBER PACKAGE, PACKAGE PRODUCT, STACKED BODY, AND METHOD FOR EXTRACTING OPTICAL FIBER

(71) Applicant: SUMITOMO ELECTRIC OPTIFRONTIER CO., LTD., Yokohama-shi (JP)

(72) Inventors: Ryo ITO, Yokohama-shi (JP); Masahiro SHIBATA, Yokohama-shi (JP); Yohei AOSHIMA, Yokohama-shi (JP); Yoshikyo TAMEKUNI, Komaki-shi (JP)

(73) Assignee: SUMITOMO ELECTRIC OPTIFRONTIER CO., LTD., Yokohama-shi (JP)

(21) Appl. No.: 19/630,833

(22) Filed: Mar. 27, 2026

(30) Foreign Application Priority Data
Mar. 28, 2025 (JP) 2025-054777

(51) Int. Cl. G02B 6/44

(52) U.S. Cl. CPC G02B 6/4453; G02B 6/44528; G02B 6/4457

(57) ABSTRACT

An optical fiber package includes: a base part; a plurality of winding parts; and a connecting part, a lower connecting part of the connecting part includes a lower hole part. The lower hole part has a lower inner major diameter and a lower inner minor diameter. The lower inner major diameter is a longest inner diameter of the lower hole part. The upper connecting part has an upper outer major diameter and an upper outer minor diameter. The upper outer major diameter is a longest outer diameter of the upper connecting part. The upper outer major diameter is longer than the lower inner minor diameter. The lower inner major diameter is longer than the upper outer major diameter. The lower inner minor diameter is longer than the upper outer minor diameter.

### TECHNICAL FIELD

The present disclosure relates to an optical fiber package, a package product, a stacked body, and a method for extracting an optical fiber. This application claims priority based on Japanese Patent Application No. 2025-054777 filed on Mar. 28, 2025, and the entire contents of which are incorporated herein by reference.

### BACKGROUND ART

JP2014-129137A discloses a package capable of accommodating an optical fiber wound therein. The optical fiber package in JP2014-129137A includes a main body, a bobbin rotatably accommodated in the main body and around which the optical fiber is wound, and a top cover that covers the main body and the bobbin. JP2014-129137A also discloses a stacked body configured such that, when a plurality of packages are stacked, an upper portion of a lower package fits into a bottom edge of the main body of an upper package.

WO2022/064747A also discloses an optical fiber package. WO2022/064747A discloses a method for extracting an optical fiber, in which a plurality of packages are attached to a rotatable jig in a stacked state, and the optical fibers are extracted together from the plurality of packages such that the plurality of optical fibers can be extracted collectively.

### SUMMARY

An object of the present disclosure is to provide an easy-to-handle optical fiber package, a package product, a stacked body, and a method for extracting an optical fiber.

According to an aspect of the present disclosure, an optical fiber package includes a base part, a plurality of winding parts protruding from a plane of the base part and configured such that an optical fiber is wound along a portion of each outer circumferential surface thereof, and a connecting part disposed in a center of the base part and including a lower connecting part protruding from the plane of the base part and an upper connecting part protruding from the lower connecting part, in which the lower connecting part includes a lower hole part having a lower inner major diameter, which is a longest inner diameter and extends in a first direction parallel to the plane, and a lower inner minor diameter, which extends in a second direction parallel to the plane and perpendicular to the first direction, the upper connecting part has an upper outer major diameter, which is a longest outer diameter and extends in the second direction, and an upper outer minor diameter, which extends in the first direction, the upper outer major diameter is longer than the lower inner minor diameter, the lower inner major diameter is longer than the upper outer major diameter, and the lower inner minor diameter is longer than the upper outer minor diameter.

### BRIEF DESCRIPTION OF THE DRAWINGS

FIG. 1 is a perspective view of an optical fiber package according to an embodiment of the present disclosure.

FIG. 2 is a perspective view showing a back side of the package illustrated in FIG. 1.

FIG. 3 is a plan view of an optical fiber package product according to an embodiment of the present disclosure.

FIG. 4 is a perspective view showing a stacked body when a plurality of packages are stacked in a first stacked state.

FIG. 5 is an enlarged cross-sectional view showing a lower connecting part of a first package and an upper connecting part of a second package in the stacked body in the first stacked state of FIG. 4.

FIG. 6 is a perspective view showing the stacked body when a plurality of packages are stacked in a second stacked state.

FIG. 7 is an enlarged cross-sectional view showing the lower connecting part of the first package and the upper connecting part of the second package in the stacked body in the second stacked state of FIG. 6.

FIG. 8 is a perspective view of a multi-package jig used to extract an optical fiber X from the package product.

FIG. 9 is a perspective view showing a state in which the package product is attached to the multi-package jig illustrated in FIG. 8.

FIG. 10 is a schematic diagram illustrating a method for extracting an optical fiber from a plurality of package products using the multi-package jig of FIG. 8.

### DETAILED DESCRIPTION

The stacked body of optical fiber packages is formed by fitting a plurality of optical fiber packages to each other and is used in various ways depending on the application and installation method. For example, when an operator extracts a plurality of optical fibers collectively from the stacked body, it is easier to collectively extract the plurality of optical fibers from the stacked body when the plurality of packages are stacked while being fitted to each other with a relatively strong force. On the other hand, when the operator removes one package from the stacked body, it is easier to remove the one package from the stacked body when the plurality of packages are stacked while being fitted to each other with a relatively weak force. As described above, with respect to a single stacked body, it is easier to handle the optical fiber packages if it is possible to selectively use between the state in which the plurality of packages are stacked while being fitted with the relatively strong force and the state in which the plurality of packages are stacked while being fitted with a relatively weak force depending on the application or the installation method.

According to the present disclosure, an easy-to-handle optical fiber package, a package product, a stacked body, and a method for extracting an optical fiber are provided.

### Description of Aspect of Present Disclosure

### First, embodiments of the present disclosure will be listed and described.

(1) An optical fiber package according to an aspect of the present disclosure includes a base part, a plurality of winding parts protruding from a plane of the base part and configured such that an optical fiber is wound along a portion of each outer circumferential surface thereof, and a connecting part disposed in a center of the base part and including a lower connecting part protruding from the plane of the base part and an upper connecting part protruding from the lower connecting part, wherein the lower connecting part includes a lower hole part, the lower hole part has a lower inner major diameter and a lower inner minor diameter, the lower inner major diameter is a longest inner diameter of the lower hole part, the lower inner major diameter extends in a first direction parallel to the plane, the lower inner minor diameter extends in a second direction parallel to the plane and perpendicular to the first direction, wherein the upper connecting part has an upper outer major diameter and an upper outer minor diameter, the upper outer major diameter is a longest outer diameter of the upper connecting part, the upper outer major diameter extends in the second direction, the upper outer minor diameter extends in the first direction, wherein the upper outer major diameter is longer than the lower inner minor diameter, wherein the lower inner major diameter is longer than the upper outer major diameter, and wherein the lower inner minor diameter is longer than the upper outer minor diameter.

The optical fiber package of the present disclosure may be used in a state in which a plurality of the packages are stacked. When stacking the plurality of packages, an operator inserts the upper connecting part of one package into the lower hole part of the lower connecting part of another package to fit the upper connecting part and the lower connecting part into each other. In the stacked body of the plurality of packages, there are two stacked states as described below. One of the stacked states is a state in which the upper connecting part and the lower connecting part are fitted together such that the upper outer major diameter of the upper connecting part of one package and the lower inner minor diameter of the lower connecting part of another package are in the same direction. The other stacked state is a state in which the upper connecting part and the lower connecting part are fitted together such that the upper outer minor diameter of the upper connecting part of one package and the lower inner minor diameter of the lower connecting part of another package are in the same direction.

In the present disclosure, the upper outer major diameter is longer than the lower inner minor diameter. For this reason, when the upper connecting part and the lower connecting part are fitted together such that the upper outer major diameter of the upper connecting part of one package and the lower inner minor diameter of the lower connecting part of another package are in the same direction, the upper connecting part is pushed into the lower hole part of the lower connecting part while the upper connecting part and the lower connecting part elastically deform with respect to each other. Accordingly, the upper connecting part and the lower connecting part are fitted together with a relatively strong force.

Furthermore, in the present disclosure, the lower inner major diameter is longer than the upper outer major diameter, and the lower inner minor diameter is longer than the upper outer minor diameter. For this reason, when the upper connecting part and the lower connecting part are fitted together such that the upper outer minor diameter of the upper connecting part of one package and the lower inner minor diameter of the lower connecting part of another package are in the same direction, the upper connecting part is pushed into the lower hole part of the lower connecting part without elastic deformation of either the upper connecting part or the lower connecting part. Accordingly, the upper connecting part and the lower connecting part are fitted together with a relatively weak force.

According to the present disclosure, by changing the direction of fitting the connecting parts of a plurality of packages, the upper connecting part and the lower connecting part can be fitted together with a relatively strong force or can be fitted together with a relatively weak force. As the fitting force between the connecting parts can be switched according to the application and installation method, the handling characteristics of the package are enhanced.

(2) The optical fiber package of (1) above may include a detachment prevention part protruding from an upper portion of the winding part and extending in a direction from the center of the base part toward an outer perimeter of the base part.

The detachment prevention part extending in the direction from the center of the base part toward the outer perimeter of the base part is provided at the upper portion of the winding part. For this reason, the position of the optical fiber with respect to the winding part is hardly changed, making it difficult for the optical fiber to slip out from the package.

(3) The optical fiber package of (1) or (2) above may further include a mounting part which is provided in a first opening between the plurality of winding parts and the connecting part and into which a connector provided on at least one end of the optical fiber is mounted, and a passage which is provided in a second opening between the plurality of winding parts and into which the optical fiber with the connector mounted on the mounting part is inserted.

According to the present disclosure, the package includes the mounting part and the passage. For this reason, while the mounting part is locking the connector of the optical fiber, it becomes easier to wind the optical fiber around the winding part, improving the handling characteristics of the package.

(4) In (2) above, the base part, the plurality of winding parts, the connecting parts, and the detachment prevention parts may be integrally formed, and when the plane of the base part is viewed in plan, the plane of the base part may include a first side, a second side adjacent to the first side, a third side adjacent to the second side and facing the first side, and a fourth side adjacent to the third side and the first side and facing the second side, in which the first side, the second side, the third side, and the fourth side may have the same length, both the first side and the third side may extend in a third direction, both the second side and the fourth side may extend in a fourth direction, the third direction and the fourth direction may be orthogonal to each other, and the detachment prevention part may be provided at an adjacent part between the first side and the second side, an adjacent part between the second side and the third side, an adjacent part between the third side and the fourth side, and an adjacent part between the fourth side and the first side.

According to the present disclosure, since the base part, the plurality of winding parts, the connecting part, and the detachment prevention part are integrally formed, the package alone can prevent the optical fiber from detaching. Accordingly, compared to the case of preventing the optical fiber from detaching with a plurality of members, the present disclosure can provide a package having a relatively simple structure.

According to the present disclosure, the plane of the base part includes the first side, the second side, the third side, and the fourth side. The first side, the second side, the third side, and the fourth side have the same length. Both the first and third sides extend in the third direction, and both the second and fourth sides extend in the fourth direction. The third and fourth directions are orthogonal to each other. The detachment prevention parts are provided at the adjacent part between the first and second sides, the adjacent part between the second and third sides, the adjacent part between the third and fourth sides, and the adjacent part between the fourth and first sides. Since four detachment prevention parts are provided on each of four adjacent parts of the plane formed from the first side to the fourth side, it is possible to prevent the optical fiber from detaching and to provide a package in which the base part and the four detachment prevention parts are integrally formed at a minimum size.

(5) In (4) above, at least one of the second side and the fourth side may include a recessed part recessed in a direction from the outer perimeter of the base part toward the center of the base part.

When a plurality of packages are stacked, it is difficult to determine from the appearance in which direction the connecting parts of the packages are fitted together. According to the present disclosure, by confirming the arrangement state of the recessed parts in the vertical direction of the plurality of stacked packages, it is easier to confirm the direction in which the connecting parts of the plurality of stacked packages are fitted together.

(6) The package product of the present disclosure includes the optical fiber including a connector mounted on at least one end thereof, and the optical fiber package described in any one of (1) to (5), in which the optical fiber may be wound across the plurality of winding parts.

The present disclosure provides the optical fiber wound around the package alone, which allows the optical fiber to be easily extracted from the package.

(7) A stacked body of optical fiber packages of the present disclosure may include a first package which is the optical fiber package described in any one of (1) to (5) and a second package which is the optical fiber package described in any one of (1) to (5) and disposed under the first package, in which the upper connecting part of the second package may be fitted into the lower hole part of the lower connecting part of the first package.

According to the present disclosure, since the upper connecting part of the second package is fitted to the lower hole part of the lower connecting part of the first package, it is possible to provide two stacked states of the stacked body of the optical fiber packages described below. One of the stacked states is a state in which the upper connecting part and the lower connecting part are fitted together such that the upper outer major diameter of the upper connecting part of the second package and the lower inner minor diameter of the lower connecting part of the first package are in the same direction. The other stacked state is a state in which the upper connecting part and the lower connecting part are fitted together such that the upper outer minor diameter of the upper connecting part of the second package and the lower inner minor diameter of the lower connecting part of the first package are in the same direction.

By changing the direction in which the connecting part of the first package and the connecting part of the second package are fitted together, the upper connecting part and the lower connecting part can be fitted together with a relatively strong force or can be fitted together with a relatively weak force. As the fitting force between the connecting parts can be switched according to the application and installation method, the handling characteristics of the package are enhanced.

(8) In (7) above, the first package and the second package may be stacked such that the first direction of the first package and the first direction of the second package may be parallel to each other.

According to the present disclosure, the upper outer major diameter of the upper connecting part of the second package and the lower inner minor diameter of the lower connecting part of the first package are parallel to each other, and the upper connecting part of the second package and the lower connecting part of the first package are fitted together with a relatively strong force. For this reason, it is easy to handle a plurality of packages together.

(9) In (7) above, the first package and the second package may be stacked such that the first direction of the first package and the first direction of the second package may be orthogonal to each other.

According to the present disclosure, the upper outer minor diameter of the upper connecting part of the second package and the lower inner minor diameter of the lower connecting part of the first package are parallel to each other, and the upper connecting part of the second package and the lower connecting part of the first package are fitted together with a relatively weak force. For this reason, it is easier to remove the first package or the second package from the stacked body.

(10) A method for extracting an optical fiber according to the present disclosure is a method for extracting a first optical fiber and a second optical fiber from the stacked body according to (8), the stacked body including a first package product in which the first optical fiber including a first connector mounted on at least one end is wound across a plurality of winding parts of a first package, and a second package product in which the second optical fiber including a second connector mounted on at least one end is wound across a plurality of winding parts of a second package, in which a connecting part of the first package product includes a first through hole that extends through an upper connecting part and a lower connecting part, a connecting part of the second package product includes a second through hole that extends through an upper connecting part and a lower connecting part, the method includes removing an end portion of the first optical fiber at a position opposite to the first connector from the first package product, and removing an end portion of the second optical fiber at a position opposite to the second connector from the second package product, and stacking the first package product and the second package product and attaching a rotatable jig to the first through hole of the first package product and the second through hole of the second package product, and the method performs pulling together the end portions removed respectively from the first package product and the second package product attached to the jig, or portions of the optical fibers connected to the end portions.

According to the present disclosure, when the end portion or a portion of the optical fiber is pulled, the package product is rotated together with the jig such that the first and second optical fibers can be easily extracted from the package. Furthermore, the first and second optical fibers can be extracted together from the first and second package products by a single pulling operation.

### Details of Embodiment of Present Disclosure

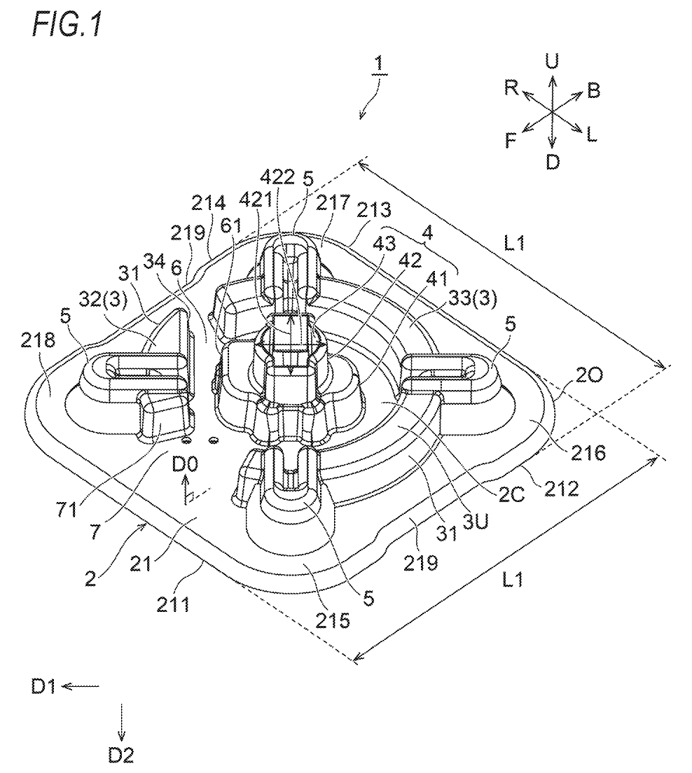

Specific examples of an optical fiber package 1 according to an embodiment of the present disclosure will be described with reference to the drawings. In the present embodiment, the terms "upward", "downward", "left direction", "right direction", "forward direction", and "backward direction" are relative directions set for the convenience of description with respect to the optical fiber package 1 illustrated in FIG. 1. Note that the present disclosure is not limited to these examples, but is indicated by the claims, and includes all modifications within the scope and meaning equivalent to the scope of the claims.

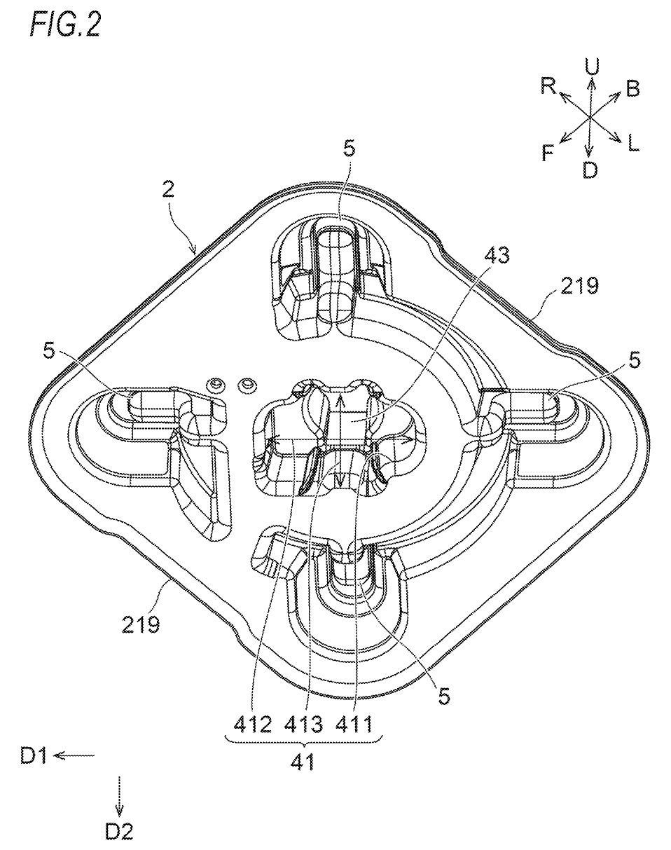

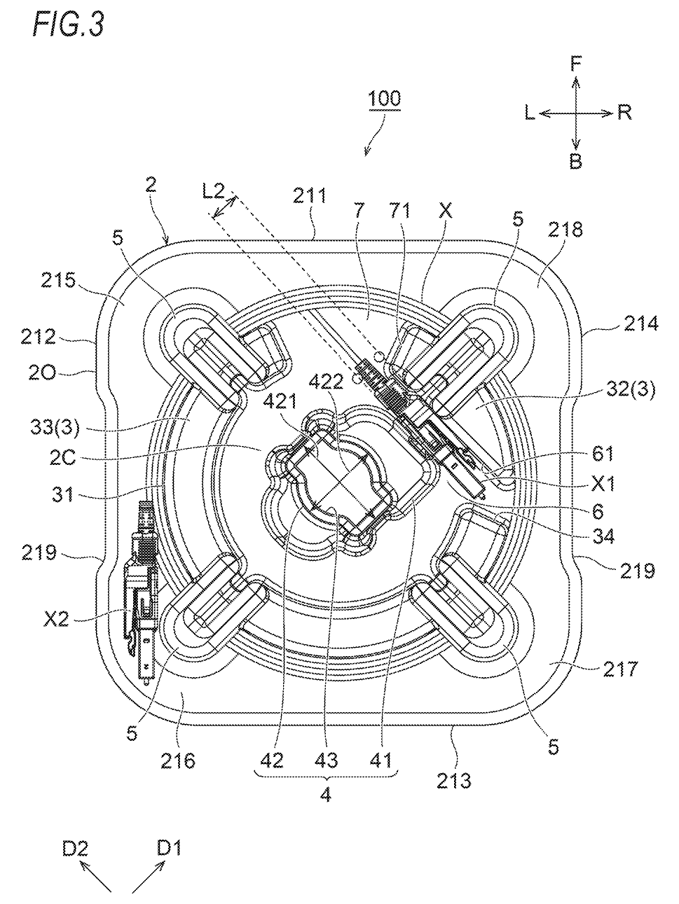

First, a configuration of the optical fiber package 1 according to an embodiment of the present disclosure will be described with reference to FIGS. 1 - 7. FIG. 1 is a perspective view of the optical fiber package 1 according to an embodiment of the present disclosure. FIG. 2 is a perspective view showing a back side of the package 1 illustrated in FIG. 1. FIG. 3 is a plan view of an optical fiber package product 100 according to the embodiment of the present disclosure. As illustrated in FIG. 3, the optical fiber package 1 is configured to accommodate an optical fiber X wound therein.

As illustrated in FIGS. 1 and 2, the package 1 includes a base part 2, a plurality of winding parts 3, a connecting part 4, a plurality of detachment prevention parts 5, a mounting part 6, and a passage 7. In the present embodiment, an arrow D0 indicates a direction (hereinafter, referred to as a normal direction D0) perpendicular to a plane 21 of the base part 2 in an upward direction.

The base part 2 has a plate shape and serves as a base of the package 1. The base part 2 has the plane 21. A thickness of the base part 2 is, for example, 1.0 to 3.0 mm. A material of the base part 2 is, for example, a synthetic resin such as polypropylene.

The base part 2 has an approximately square shape in a plan view of the base part 2. More specifically, when the plane 21 of the base part 2 is viewed in a plan view, the plane 21 of the base part 2 includes a first side 211, a second side 212 adjacent to the first side 211, a third side 213 adjacent to the second side 212 and facing the first side 211, and a fourth side 214 adjacent to the third side 213 and the first side 211 and facing the second side 212. The first side 211, the second side 212, the third side 213, and the fourth side 214 have the same length L1. Both the first side 211 and the third side 213 extend in a left direction. Both the second side 212 and the fourth side 214 extend in a forward direction. The left direction and the forward direction are orthogonal to each other. The left direction is an example of a third direction. The forward direction is an example of a fourth direction.

In the plan view of the base part 2, at least one of the second side 212 and the fourth side 214 includes a recessed part 219 recessed in a direction from an outer perimeter 2O of the base part 2 toward a center 2C. In the present embodiment, the recessed part 219 is provided on both the second side 212 and the fourth side 214. The recessed part 219 extends in the forward direction.

The plurality of winding parts 3 protrude from the plane 21 of the base part 2 in the normal direction D0. The plurality of winding parts 3 are provided to surround the center 2C of the base part 2. The optical fiber X is wound across the plurality of winding parts 3 on the plane 21, along a portion of an outer circumferential surface 31 of each winding part 3 (see FIG. 3). In the present embodiment, the plurality of winding parts 3 include a first winding part 32 and a second winding part 33. On the plane 21, the first winding part 32 and the second winding part 33 are disposed spaced apart from each other. The outer circumferential surface 31 of the first winding part 32 is smaller than the outer circumferential surface 31 of the second winding part 33.

The optical fiber X is wound along the outer circumferential surfaces 31 of the two winding parts 3 in an approximately circular shape. In this example, "along the outer circumferential surface 31" includes not only a state in which the optical fiber X is in direct contact with the outer circumferential surface 31 of the winding part 3, but also a state in which it is wound in an approximately circular shape to have a radius of curvature equal to or greater than that of the outer circumferential surface 31.

The plurality of winding parts 3 are integrally formed with the base part 2. The phrase "integrally formed" as used herein refers to being formed from a single member (that is, formed to have a monolithic structure). The plurality of winding parts 3 may be molded together with the base part 2 by injection molding a synthetic resin such as polypropylene using a mold, for example.

The outer circumferential surface 31 of each winding part 3 has an arc shape in the plan view of the base part 2. The outer circumferential surface 31 may be perpendicular to the plane 21 of the base part 2. In addition, although two winding parts 3 are formed in the package 1, the number of winding parts 3 is not limited to two. The package 1 may include three or more winding parts 3 according to an allowable radius of curvature of the optical fiber X.

The connecting part 4 is disposed in the center 2C of the base part 2. The connecting part 4 is integrally formed with the base part 2. The connecting part 4 includes a lower connecting part 41, an upper connecting part 42, and a through hole 43. The lower connecting part 41 protrudes from the plane 21 of the base part 2 in the normal direction D0. The upper connecting part 42 protrudes from an upper portion of the lower connecting part 41 in the normal direction D0. The through hole 43 is a hole extending through the upper connecting part 42 and the lower connecting part 41 in the normal direction D0. The through hole 43 is configured to allow attachment of a multi-package jig 8 to be described below. Details of the connecting part 4 will be described below.

The plurality of detachment prevention parts 5 are integrally formed with the base part 2. Each detachment prevention part 5 is configured to regulate the position of the optical fiber X wound across the plurality of winding parts 3. Specifically, each detachment prevention part 5 is configured to regulate the position of the optical fiber X in the normal direction D0 with respect to the plane 21 of the base part 2. Each detachment prevention part 5 extends in a direction along the plane 21 of the base part 2.

Each detachment prevention part 5 is integrally formed with the winding part 3, protrudes in a direction from an upper portion 3U of the winding part 3, and also extends in a direction from the center 2C of the base part 2 toward the outer perimeter 2O of the base part 2. For example, in the plan view of the base part 2, the length of the detachment prevention part 5 may be appropriately set to a dimension such that the optical fiber X wound around the plurality of winding parts 3 is covered by the detachment prevention part 5.

The package 1 of this embodiment includes four detachment prevention parts 5. The four detachment prevention parts 5 are provided at four corners of the plane 21 of the base part 2. More specifically, the four detachment prevention parts 5 are provided at a first adjacent part 215 between the first side 211 and the second side 212, a second adjacent part 216 between the second side 212 and the third side 213, a third adjacent part 217 between the third side 213 and the fourth side 214, and a fourth adjacent part 218 between the fourth side 214 and the first side 211, respectively.

As illustrated in FIG. 3, the package product 100 includes the optical fiber X with a connector mounted on at least one end, and the optical fiber package 1. In the package product 100, the optical fiber X is wound across the plurality of winding parts 3 of the package 1.

In the present embodiment, the optical fiber X is an optical fiber with a connector including a first connector X1 and a second connector X2 at end portions, respectively. In the present example, the first connector X1 and the second connector X2 may have the same shape, or may have different shapes from each other. When the optical fiber X includes only one connector, the end portion without the connector is formed for fusion splicing with other optical fibers and optical components, for example. In this case, the end portion of the package 1 without the connector may be fixed to the plane 21 of the base part 2 with tape.

As illustrated in FIGS. 1 and 3, the mounting part 6 is configured such that the first connector X1 of the optical fiber X is mounted thereon. The mounting part 6 is provided in a first opening 61 formed between the plurality of winding parts 3 and the connecting part 4. In the present embodiment, the first opening 61 is on the plane 21 of the base part 2 and is formed between the first winding part 32 and the lower connecting part 41. The first opening 61 extends on the plane 21 of the base part 2 in a direction that intersects with any side of the plane 21. In the present embodiment, the first opening 61 extends in a left-front direction. The first opening 61 may communicate with an opening 34 formed between the first winding part 32 and the second winding part 33.

In the plan view of the base part 2, a width L2 of the mounting part 6, which is a length between the first winding part 32 and the lower connecting part 41, is less than a width dimension of the first connector X1 of the optical fiber X. For this reason, when the first connector X1 of the optical fiber X is pushed into the first opening 61 of the mounting part 6, the first winding part 32 and the lower connecting part 41 elastically deform to move away from each other up to the width dimension of the first connector X1, and the first connector X1 of the optical fiber X is clamped between the first winding part 32 and the lower connecting part 41. Thus, the first connector X1 of the optical fiber X is mounted on the mounting part 6.

As illustrated in FIGS. 1 and 3, the passage 7 is configured such that the optical fiber X having the first connector X1 mounted in the mounting part 6 can be inserted therethrough. The passage 7 is provided in a second opening 71 between the first winding part 32 and the second winding part 33. The second opening 71 is in communication with the first opening 61. The larger the second opening 71 between the first winding part 32 and the second winding part 33, the optical fiber X in a state in which the first connector X1 is mounted on the mounting part 6 is bent with a larger radius of curvature and is more likely to be wound around the outer circumferential surface 31 of the second winding part 33.

### Next, the details of the connecting part 4 will be described.

As illustrated in FIG. 2, the lower connecting part 41 of the connecting part 4 includes a lower hole part 411. The lower hole part 411 is a portion of the through hole 43. The lower hole part 411 has a lower inner major diameter 412 and a lower inner minor diameter 413. The lower inner major diameter 412 is the longest inner diameter in the lower hole part 411 and extends in a first direction D1 parallel to the plane 21 of the base part 2. The first direction D1 is a right-front direction, for example. The lower inner minor diameter 413 extends in a second direction D2 parallel to the plane 21 of the base part 2 and orthogonal to the first direction D1. The second direction D2 is a left-front direction, for example.

As illustrated in FIGS. 1 and 3, the upper connecting part 42 includes an upper outer major diameter 421 and an upper outer minor diameter 422. The upper outer major diameter 421 is the longest outer diameter of the upper connecting part 42 and extends in the second direction D2 parallel to the plane 21 of the base part 2. The upper outer minor diameter 422 extends in the first direction D1 parallel to the plane 21 of the base part 2.

In the present embodiment, the upper outer major diameter 421 of the upper connecting part 42 is longer than the lower inner minor diameter 413 of the lower connecting part 41. The lower inner major diameter 412 of the lower connecting part 41 is longer than the upper outer major diameter 421 of the upper connecting part 42. Further, the lower inner minor diameter 413 of the lower connecting part 41 is longer than the upper outer minor diameter 422 of the upper connecting part 42.

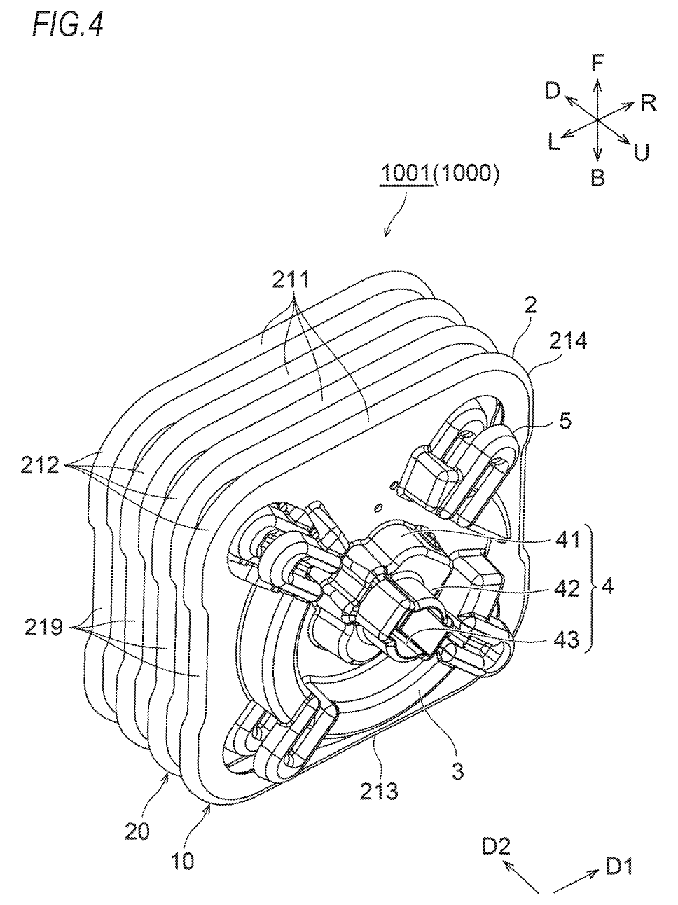

Next, the operation and effect of the connecting part 4 will be described with reference to FIGS. 4 - 7.

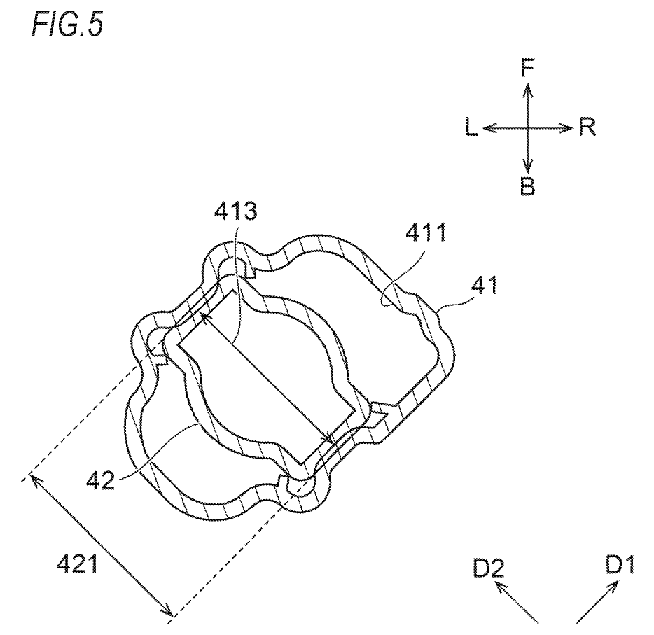

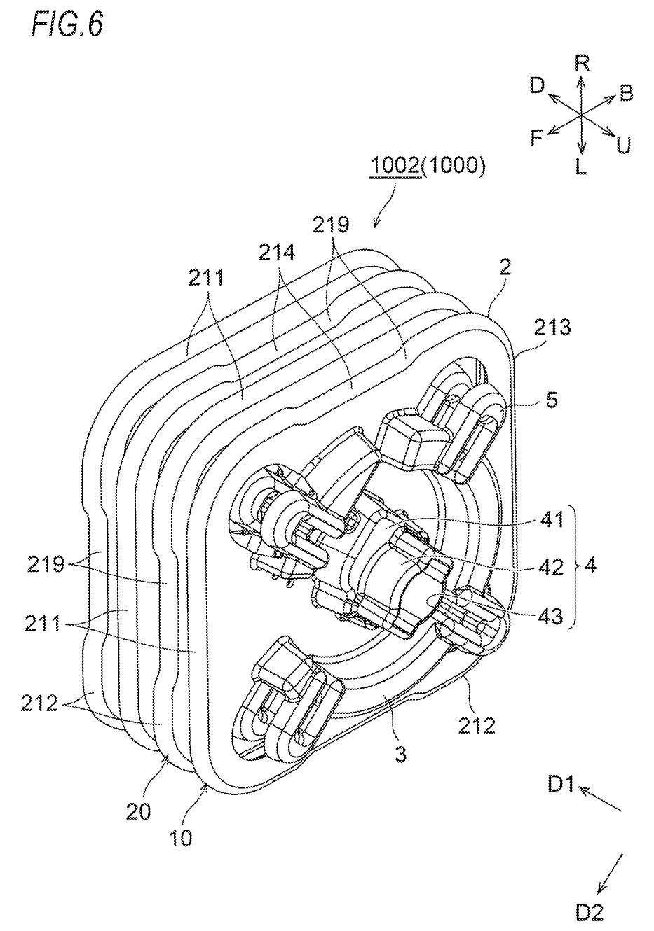

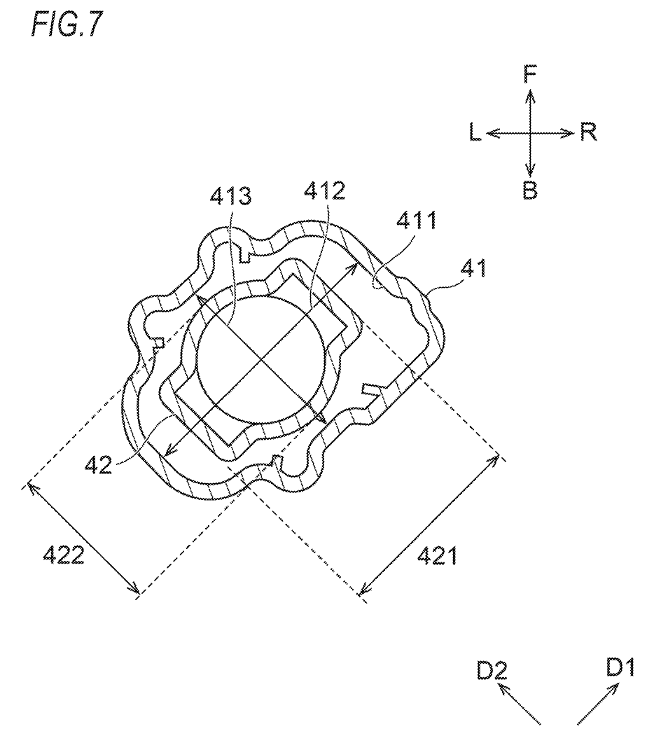

FIG. 4 is a perspective view showing a stacked body 1001 when a plurality of packages 1 are stacked in a first stacked state. FIG. 5 is an enlarged cross-sectional view showing the lower connecting part 41 of a first package 10 and the upper connecting part 42 of a second package 20 in the stacked body 1001 in the first stacked state of FIG. 4. FIG. 6 is a perspective view showing a stacked body 1002 when the plurality of packages 1 are stacked in a second stacked state. FIG. 7 is an enlarged cross-sectional view showing the lower connecting part 41 of the first package 10 and the upper connecting part 42 of the second package 20 in the stacked body 1002 in the second stacked state of FIG. 6.

In the present embodiment, a stacked body of the plurality of packages 1 is referred to as a stacked body 1000 of the optical fiber package. As illustrated in FIGS. 4 and 6, in the stacked body 1000 of the optical fiber packages, the connecting part 4 of one package 1 and the connecting part 4 of the package 1 disposed under the one package are connected to each other. The stacked body 1000 illustrated in FIGS. 4 and 6 is in a state in which four packages 1 are stacked by way of example, but the number of packages to be stacked is not limited to four. Hereinafter, for simplicity of description, a state in which two packages 1 are stacked, including the first optical fiber package 10 and the second optical fiber package 20 disposed under the first package 10, will be described. In addition, the direction of the stacked body 1000 is the same as the direction of the first optical fiber package 10 disposed on the uppermost part of the stacked body 1000.

In the stacked body 1000 of the optical fiber packages of the present embodiment, the upper connecting part 42 of the second package 20 is inserted into the lower hole part 411 of the lower connecting part 41 of the first package 10, and the lower connecting part 41 of the first package 10 and the upper connecting part 42 of the second package 20 are fitted together. In the present embodiment, the stacked state of the stacked body 1000 includes the first stacked state and the second stacked state.

The first stacked state is a state in which the first package 10 and the second package 20 are stacked such that the first direction D1 of the first package 10 and the first direction D1 of the second package 20 are parallel to each other, as illustrated in FIG. 4. The stacked body in the first stacked state is referred to as the stacked body 1001. In the stacked body 1001, the recessed part 219 of the first package 10 and the recessed part 219 of the second package 20 face the same direction. For example, when the stacked body 1001 in the first stacked state is viewed from the forward direction or the backward direction, the first package 10 and the second package 20 are stacked such that the first sides 211 or the third sides 213 where the recessed part 219 is not formed are aligned in a vertical direction. When the stacked body 1001 in the first stacked state is viewed from the left direction or the right direction, the first package 10 and the second package 20 are stacked such that the second sides 212 or the fourth sides 214 where the recessed part 219 is formed are aligned in the vertical direction.

FIG. 5 is an enlarged cross-sectional view showing the lower connecting part 41 of the first package 10 and the upper connecting part 42 of the second package 20 in the stacked body 1001 in the first stacked state. As illustrated in FIG. 5, in the stacked body 1001 in the first stacked state, the lower connecting part 41 and the upper connecting part 42 are fitted together such that the lower inner minor diameter 413 of the lower connecting part 41 of the first package 10 and the upper outer major diameter 421 of the upper connecting part 42 of the second package 20 are in the same direction.

In the present embodiment, the upper outer major diameter 421 of the upper connecting part 42 of the second package 20 is longer than the lower inner minor diameter 413 of the lower connecting part 41 of the first package 10. For example, the upper outer major diameter 421 is 30 mm, and the lower inner minor diameter 413 is 28 mm. For this reason, in the stacked body 1001 in the first stacked state, the lower connecting part 41 of the first package 10 and the upper connecting part 42 of the second package 20 elastically deform with respect to each other, and the upper connecting part 42 of the second package 20 is pushed into the lower hole part 411 of the lower connecting part 41 of the first package 10. Accordingly, the lower connecting part 41 of the first package 10 and the upper connecting part 42 of the second package 20 are fitted together with a relatively strong force.

The second stacked state is a state in which the first package 10 and the second package 20 are stacked such that the first direction D1 of the first package 10 and the first direction D1 of the second package 20 are orthogonal to each other, as illustrated in FIG. 6. The stacked body in the second stacked state is referred to as the stacked body 1002. In the stacked body 1002, the recessed part 219 of the first package 10 and the recessed part 219 of the second package 20 face different directions from each other. For example, when the stacked body 1002 in the second stacked state is viewed from the forward direction, the first package 10 and the second package 20 are stacked such that the first side 211 of the first package 10 where the recessed part 219 is not formed, and the second side 212 of the second package 20 where the recessed part 219 is formed, are aligned in the vertical direction. When the stacked body 1002 in the second stacked state is viewed from the right direction, the first package 10 and the second package 20 are stacked such that the fourth side 214 of the first package 10 where the recessed part 219 is formed, and the first side 211 of the second package 20 where the recessed part 219 is not formed, are aligned in the vertical direction.

FIG. 7 is an enlarged cross-sectional view showing the lower connecting part 41 of the first package 10 and the upper connecting part 42 of the second package 20 in the stacked body 1002 in the second stacked state. As illustrated in FIG. 7, in the stacked body 1002 in the second stacked state, the lower connecting part 41 and the upper connecting part 42 are fitted together such that the lower inner minor diameter 413 of the lower connecting part 41 of the first package 10 and the upper outer minor diameter 422 of the upper connecting part 42 of the second package 20 are in the same direction.

In the present embodiment, the lower inner major diameter 412 of the lower connecting part 41 of the first package 10 is longer than the upper outer major diameter 421 of the upper connecting part 42 of the second package 20. Furthermore, the lower inner minor diameter 413 of the lower connecting part 41 of the first package 10 is longer than the upper outer minor diameter 422 of the upper connecting part 42 of the second package 20. For this reason, in the stacked body 1002 in the second stacked state, neither the lower connecting part 41 of the first package 10 nor the upper connecting part 42 of the second package 20 deforms elastically, and the upper connecting part 42 of the second package 20 is pushed into the lower hole part 411 of the lower connecting part 41 of the first package 10. Accordingly, the lower connecting part 41 of the first package 10 and the upper connecting part 42 of the second package 20 are fitted together with a relatively weak force.

For example, there are situations where the operator transports the stacked body 1000 of the optical fiber package as a single unit or extracts a plurality of optical fibers collectively from the stacked body 1000. In such a case, it is easier to collectively extract the plurality of optical fibers X from the stacked body 1001 when the first package 10 and the second package 20 are stacked while being fitted together with a relatively strong force, as in the first stacked state. Meanwhile, there are situations where the operator removes the first package 10 from the stacked body 1000 for use. In such a case, it is easier to remove the first package 10 from the stacked body 1002 when the first package 10 and the second package 20 are stacked while being fitted together with a relatively weak force, as in the second stacked state.

As described above, according to the present embodiment, by changing the fitting direction of the lower connecting part 41 of the first package 10 and the upper connecting part 42 of the second package 20, the lower connecting part 41 of the first package 10 and the upper connecting part 42 of the second package 20 can be fitted together with a relatively strong force or can be fitted together with a relatively weak force. Since the fitting force of the connecting parts 4 can be switched according to the application and installation method, the handling characteristics of the optical fiber package 1 are enhanced.

The package product 100 of the present embodiment provides the optical fiber X wound around the package 1 alone, which allows the optical fiber X to be easily extracted from the package 1.

According to the present embodiment, the detachment prevention part 5 extending in a direction from the center 2C of the base part 2 toward the outer perimeter 2O of the base part 2 is provided in the upper portion 3U of the winding part 3. For this reason, the position of the optical fiber X in the normal direction D0 with respect to the winding part 3 is hardly changed, making it difficult for the optical fiber X to slip out from the package 1.

According to the present embodiment, the package 1 includes the mounting part 6 and the passage 7. For this reason, while the mounting part 6 is locking the first connector X1 of the optical fiber X, it becomes easier to wind the optical fiber X around the winding part 3, improving the handling characteristics of the optical fiber package 1.

According to the present embodiment, the base part 2, the plurality of winding parts 3, the connecting part 4, and the detachment prevention part 5 are integrally formed such that the package 1 alone can prevent the optical fiber X from detaching. Therefore, compared to the case of preventing the optical fiber X from detaching with a plurality of members, the present embodiment can provide the package 1 having a relatively simple structure.

Further, the plane 21 of the base part 2 includes the first side 211, the second side 212, the third side 213, and the fourth side 214. The first side 211, the second side 212, the third side 213, and the fourth side 214 have the same length. Both the first side 211 and the third side 213 extend in the left direction, and both the second side 212 and the fourth side 214 extend in the forward direction. The left direction and the forward direction are orthogonal to each other. The four detachment prevention parts 5 are provided on each of the four adjacent parts of the plane 21 formed by the first side 211 through the fourth side 214. To this end, the present embodiment can prevent the optical fiber X from detaching and also provide the package 1 in which the base part 2 and the four detachment prevention parts 5 are integrally formed at a minimum size.

The stacked body 1000, in which the plurality of packages 1 are stacked, makes it difficult from its appearance to determine a direction in which the connecting parts of the plurality of packages 1 are fitted together. According to the present embodiment, as illustrated in FIG. 4, in the stacked body 1001 in the first stacked state, the plurality of packages 1 are stacked such that only the sides where the recessed part 219 is not formed are aligned in the vertical direction, and only the sides where the recessed part 219 is formed are aligned in the vertical direction. As illustrated in FIG. 6, in the stacked body 1002 in the second stacked state, the plurality of packages 1 are stacked such that the sides where the recessed part 219 is formed and the sides where the recessed part 219 is not formed are alternately aligned in the vertical direction. As described above, by confirming the arrangement state of the recessed parts 219 in the vertical direction of the stacked body 1000, it is easier to confirm the direction in which the connecting parts 4 of the plurality of stacked packages 1 are fitted together.

In the present embodiment, as the stacked body 1001 in the first stacked state, the first package 10 and the second package 20 are stacked such that the first direction D1 of the first package 10 and the first direction D1 of the second package 20 are parallel to each other. The lower inner minor diameter 413 of the lower connecting part 41 of the first package 10 and the upper outer major diameter 421 of the upper connecting part 42 of the second package 20 are parallel to each other, and the lower connecting part 41 of the first package 10 and the upper connecting part 42 of the second package 20 are fitted together with a relatively strong force. For this reason, it is easy to handle the first package 10 and the second package 20 together.

In the present embodiment, as the stacked body 1002 in the second stacked state, the first package 10 and the second package 20 are stacked such that the first direction D1 of the first package 10 and the first direction D1 of the second package 20 are orthogonal to each other. The lower inner minor diameter 413 of the lower connecting part 41 of the first package 10 and the upper outer minor diameter 422 of the upper connecting part 42 of the second package 20 are parallel to each other, and the lower connecting part 41 of the first package 10 and the upper connecting part 42 of the second package 20 are fitted together with a relatively weak force. For this reason, it is easier to remove the first package 10 from the stacked body 1002.

### Extraction Method

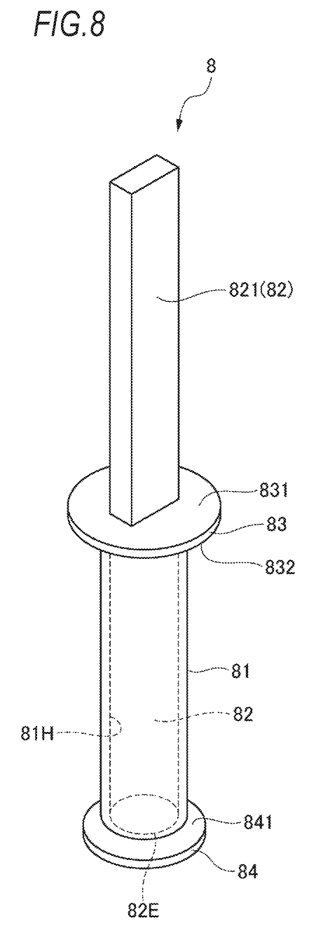

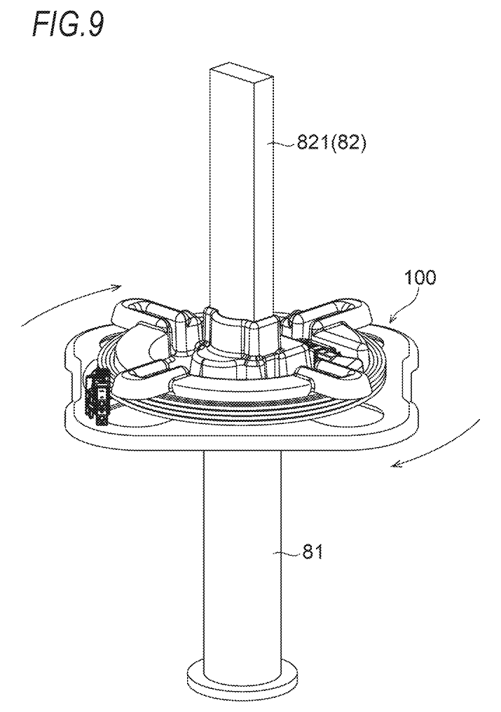

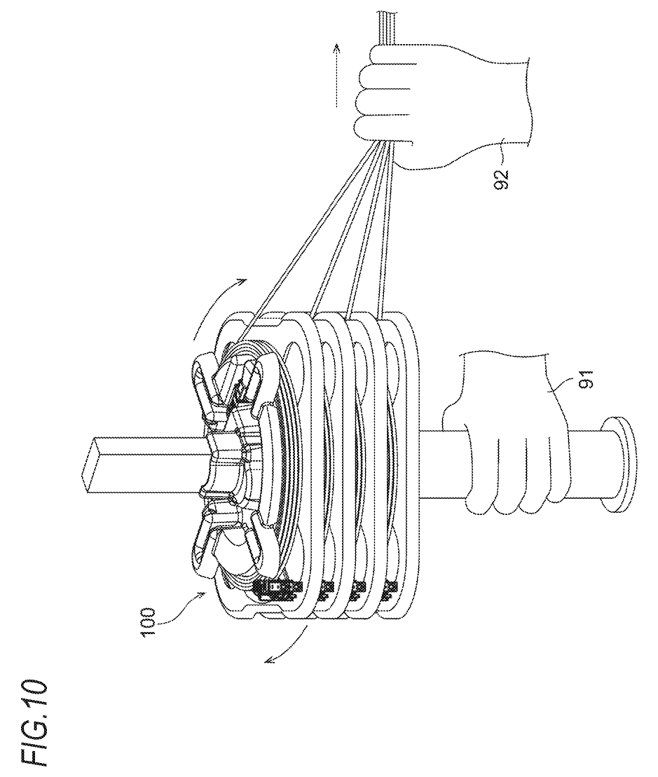

Using FIGS. 8- 10, a method for extracting the optical fiber X from the optical fiber package product 100 will be described. FIG. 8 is a perspective view of the multi-package jig 8 used to extract the optical fiber X from the package product 100. FIG. 9 is a perspective view showing a state in which the package product 100 is attached to the multi-package jig 8 illustrated in FIG. 8. FIG. 10 is a schematic diagram illustrating a method for extracting the optical fiber X from a plurality of package products 100 using the multi-package jig 8 of FIG. 8. In addition, the extraction method of the present disclosure can be applied without any particular limitation, provided that the package is one in which the optical fiber X with a connector mounted on at least one end is wound and that the connector is locked near the outer perimeter of the package. The multi-package jig 8 is an example of a jig.

As illustrated in FIG. 8, the multi-package jig 8 to which the package product 100 is attached includes a gripping part 81, a shaft part 82, a support part 83, and an abutting part 84. The gripping part 81 can be gripped by the operator and supports the shaft part 82 rotatably. In the present embodiment, the gripping part 81 has a cylindrical shape, and a through hole 81H extending in an axial direction is formed inside the gripping part 81. The shaft part 82 has a shape of a rod, and a portion of the shaft part 82 is inserted into the through hole 81H of the gripping part 81. In the present example, the portion of the shaft part 82 inserted into the through hole 81H has a cylindrical shape. That is, the shaft part 82 is connected to the gripping part 81 so as to be rotatable around the axial direction. It is to be noted that the shape of the gripping part 81 is not limited to a cylinder or a square column.

The shaft part 82 includes an insertion part 821 to which the package product 100 is attached. The insertion part 821 is formed to be fitted to the through hole 43 of the package product 100. In the present embodiment, the insertion part 821 includes a square column extending in the axial direction. The package product 100 is attached to the shaft part 82 by inserting the insertion part 821 into the through hole 43 of the package product 100. It is to be noted that the shape of the insertion part 821 of the shaft part 82 is not limited to a cylinder or a square column.

The support part 83 supports the package product 100 attached to the shaft part 82. Specifically, the support part 83 is provided on the shaft part 82 and includes a placement surface 831 allowing the package product 100 to be placed. The package product 100 guided to the insertion part 821 by the through hole 43 is placed on the placement surface 831 (see FIG. 9). A surface 832 on the opposite side of the placement surface 831 of the support part 83 serves as an abutting surface abutting on the gripping part 81 when the shaft part 82 is displaced in the rotational axis direction with respect to the gripping part 81. In the present embodiment, the support part 83 has a disk shape extending radially from the shaft part 82 as its center, and when the multi-package jig 8 is viewed from the axial direction of the shaft part 82, the support part 83 is formed to be greater than the gripping part 81. It is to be noted that the shape of the support part 83 is not limited to a disk.

The abutting part 84 is provided at an end portion 82E of the shaft part 82. The abutting part 84 includes an abutting surface 841 abutting on the gripping part 81 when the shaft part 82 is displaced in the rotational axis direction with respect to the gripping part 81. In the present embodiment, the abutting part 84 has a disk shape, and when the multi-package jig 8 is viewed from the axial direction of the shaft part 82, the abutting surface 841 is formed to be greater than the gripping part 81. It is to be noted that the shape of the abutting part 84 is not limited to a disk.

When the operator extracts the optical fiber X from the package product 100, the operator attaches the package product 100 to the shaft part 82 as illustrated in FIG. 9 (step S1). The second connector X2 locked near the outer perimeter of the package product 100 is removed from the package product 100 (step S2). Then, the operator grips the gripping part 81 with one hand and pulls the detached second connector X2 or the optical fiber X connected to the second connector X2 with the other hand (step S3). At this time, since the shaft part 82 is rotated with respect to the gripping part 81, the insertion part 821 and the package product 100 inserted into the insertion part 821 are rotated around the rotational axis of the shaft part 82. In this way, when the second connector X2 or a portion of the optical fiber X removed from the package product 100 is pulled, the package product 100 is rotated together with the shaft part 82 of the multi-package jig 8 such that the optical fiber X can be easily extracted from the package product 100. Further, when the shaft part 82 is displaced in the rotational axis direction with respect to the gripping part 81, since the abutting part 84 abuts on the gripping part 81, the shaft part 82 can be prevented from disengaging from the gripping part 81. It is to be noted that steps S1 and S2 may be performed in any order. Performing step S1 first improves the handling characteristics compared to performing step S2 first.

In FIG. 9, although one package product 100 is attached to the multi-package jig 8, the plurality of package products 100 can be attached to the multi-package jig 8 and stacked as illustrated in FIG. 10, and the plurality of optical fibers X can be extracted collectively from the plurality of package products 100. Specifically, the plurality of package products 100 are attached to the shaft part 82 (step S11). The second connector X2 locked near the outer perimeter of the package product 100 is removed from the package product 100 (step S12). Then, the operator grips the gripping part 81 with one hand 91 and extracts together the second connectors X2, which are removed from the plurality of package products 100 attached to the shaft part 82 respectively, or portions of the optical fibers X connected to the second connectors X2 with the other hand 92 (step S13). As a result, the optical fibers X can be extracted together from the plurality of package products 100 by a single pulling operation. It is to be noted that steps S11 and S12 may be performed in any order. Performing step S11 first improves the handling characteristics compared to performing step S12 first.

Since the through hole 43 is a non-circular hole, it is possible to prevent the plurality of stacked package products 100 from individually being rotated to the insertion part 821. That is, the operator can collectively rotate the plurality of package products 100 together with the insertion part 821 at the same cycle.

For example, the second connectors X2 respectively removed from the plurality of package products 100 are connected to an external device. The second connectors X2 may be connected to the external device after the optical fiber X is extracted from the package product 100, or may be connected to the external device before the optical fiber X is extracted from the package product 100.

What is claimed is:

1. An optical fiber package comprising:
a base part;
a plurality of winding parts protruding from a plane of the base part and configured such that an optical fiber is wound along a portion of each outer circumferential surface thereof; and
a connecting part disposed in a center of the base part and including a lower connecting part protruding from the plane of the base part and an upper connecting part protruding from the lower connecting part,
wherein the lower connecting part includes a lower hole part, the lower hole part has a lower inner major diameter and a lower inner minor diameter, the lower inner major diameter is a longest inner diameter of the lower hole part, the lower inner major diameter extends in a first direction parallel to the plane, the lower inner minor diameter extends in a second direction parallel to the plane and perpendicular to the first direction,
wherein the upper connecting part has an upper outer major diameter and an upper outer minor diameter, the upper outer major diameter is a longest outer diameter of the upper connecting part, the upper outer major diameter extends in the second direction, the upper outer minor diameter extends in the first direction,
wherein the upper outer major diameter is longer than the lower inner minor diameter,
wherein the lower inner major diameter is longer than the upper outer major diameter, and
wherein the lower inner minor diameter is longer than the upper outer minor diameter.

2. The optical fiber package according to claim 1, further comprising a detachment prevention part protruding from an upper portion of the winding part and extending in a direction from the center of the base part toward an outer perimeter of the base part.

3. The optical fiber package according to claim 1, further comprising:
a mounting part being provided in a first opening between the plurality of winding parts and the connecting part and into which a connector provided on at least one end of the optical fiber is mounted; and
a passage being provided in a second opening between the plurality of winding parts and into which the optical fiber with the connector mounted on the mounting part is inserted.

4. The optical fiber package according to claim 2,
wherein the base part, the plurality of winding parts, and the connecting parts are integrally formed,
wherein when the plane of the base part is viewed in plan, the plane of the base part includes a first side, a second side adjacent to the first side, a third side adjacent to the second side and facing the first side, and a fourth side adjacent to the third side and the first side and facing the second side,
wherein the first side, the second side, the third side, and the fourth side have the same length,
wherein both the first side and the third side extend in a third direction,
wherein both the second side and the fourth side extend in a fourth direction,
wherein the third direction and the fourth direction are orthogonal to each other, and
wherein the detachment prevention part is provided at an adjacent part between the first side and the second side, an adjacent part between the second side and the third side, an adjacent part between the third side and the fourth side, and an adjacent part between the fourth side and the first side.

5. The optical fiber package according to claim 4, wherein at least one of the second side and the fourth side includes a recessed part recessed in a direction from the outer perimeter of the base part toward the center of the base part.

6. A package product comprising:
an optical fiber including a connector mounted on at least one end thereof; and
the optical fiber package according to claim 1,
wherein the optical fiber is wound across the plurality of winding parts.

7. A stacked body of optical fiber packages, comprising:
a first package being the optical fiber package according to claim 1, and
a second package being the optical fiber package according to claim 1 and being disposed under the first package,
wherein the upper connecting part of the second package is fitted to the lower hole part of the lower connecting part of the first package.

8. The stacked body of the optical fiber package according to claim 7, wherein the first package and the second package are stacked such that a first direction of the first package and a first direction of the second package are parallel to each other.

9. The stacked body of the optical fiber package according to claim 7, wherein the first package and the second package are stacked such that a first direction of the first package and a first direction of the second package are orthogonal to each other.

10. A method for extracting an optical fiber, wherein the method is for extracting a first optical fiber and a second optical fiber from the stacked body according to claim 8, the stacked body including: a first package product in which the first optical fiber including a first connector mounted on at least one end is wound across a plurality of winding parts of a first package; and a second package product in which the second optical fiber including a second connector mounted on at least one end is wound across a plurality of winding parts of a second package,
wherein a connecting part of the first package product includes a first through hole that extends through an upper connecting part and a lower connecting part,
wherein a connecting part of the second package product includes a second through hole that extends through an upper connecting part and a lower connecting part,
wherein the method comprises:
removing an end portion of the first optical fiber at a position opposite to the first connector from the first package product, and removing an end portion of the second optical fiber at a position opposite to the second connector from the second package product; and
stacking the first package product and the second package product and attaching a rotatable jig to the first through hole of the first package product and the second through hole of the second package product, and
wherein the method performs pulling together the end portions removed respectively from the first package product and the second package product attached to the jig, or portions of the optical fibers connected to the end portions.
